(19) United States
(12) Patent Application Publication
(10) Pub. No.: US 2019/0155472 A1
(43) Pub. Date: May 23, 2019

(54) INFORMATION PROCESSING DEVICE, AND CONTROL METHOD FOR INFORMATION PROCESSING DEVICE

(71) Applicant: SHARP KABUSHIKI KAISHA, Sakai City, Osaka (JP)

(72) Inventors: MAKIO TOMITA, Sakai City (JP); SUSUMU HASEGAWA, Sakai City (JP)

(21) Appl. No.: 16/099,671

(22) PCT Filed: Mar. 22, 2017
(86) PCT No.: PCT/JP2017/011367

§ 371 Date: Nov. 7, 2018

(30) Foreign Application Priority Data
May 11, 2016 (JP) 2016-095391

(51) Int. Cl. G06F 3/0485; G06F 3/0488

(52) U.S. Cl. CPC G06F 3/0485; G06F 3/04883

(57) ABSTRACT

In order to provide a user with a smooth operational feeling in a case where the user successively carries out scrolling of a display object and controlling of a pointer, a mobile terminal (1) includes a pointer moving section (232) and a scrolling executing section (233). The pointer moving section (232) is configured to move a pointer in accordance with a sliding operation received. The scrolling executing section (233) is configured to continuously execute scrolling of the display object in a case where the pointer has reached an end of a display section by the sliding operation.

### TECHNICAL FIELD

The present invention relates to an information processing device that includes (i) a display section for displaying a display object and (ii) a touch operation section for accepting a touch operation carried out by a user.

### BACKGROUND ART

Conventionally, there has been known an information processing device that carries out scrolling, in accordance with a user operation, of a display object so as to allow the user to view the entirety of the display object (e.g., a web page, a large-sized image, or items listed in many lines) that cannot be displayed entirely within a display screen. For example, Patent Literature 1 listed below discloses a technique of scrolling a display object. According to the technique, a special cursor appears on a screen when the screen is tapped. Then, in a case where an indicator (such as a user's finger) is moved in a vertical direction while being kept in contact with the screen on which the special cursor is appearing, the display object is scrolled in a direction corresponding to a direction in which the finger is moved and at a velocity corresponding to a distance by which the finger is moved.

### Citation List

### Patent Literature

[Patent Literature 1]

Japanese Patent Application Publication Tokukai No. 2012-33058 (Publication date: Feb. 16, 2012)

### SUMMARY OF INVENTION

### Technical Problem

Here, an information processing device is to be discussed in which not only a display object is scrolled in accordance with an operation carried out with an indicator but also a pointer for selecting a content in the display object is displayed, and then the pointer is moved in accordance with an operation carried out with the indicator, and a content is selected in accordance with an operation carried out with the indicator. In using such an information processing device, a display object scrolling process and a pointer controlling process need to be carried out by operations carried out with the indicator. However, according to the conventional technique, the display object scrolling process and the pointer controlling process are realized by different operations. Therefore, in a case where the display object scrolling process and the pointer controlling process are successively carried out, a user needs to carry out two or more operations, i.e., the user needs to carry out a given operation for terminating one process and then carry out a separate operation for starting the other process. That is, the conventional technique cannot provide the user with a smooth operational feeling in a case where the user successively carries out scrolling of a display object and controlling of a pointer.

An aspect of the present invention is made in view of the above issue, and an object of the present invention is to provide, for example, an information processing device that provides a user with a smooth operational feeling in a case where the user successively carries out scrolling of a display object and controlling of a pointer.

### Solution to Problem

In order to attain the above object, a mobile terminal in accordance with an aspect of the present invention is an information processing device, including: a display section configured to display a partial region of a display object; a touch operation section configured to accept a touch operation in which an indicator is brought into contact with or brought closer to the touch operation section; a pointer moving section configured to move a pointer in accordance with a moving operation which has been received by the touch operation section and in which the indicator is moved while being kept in contact with or in proximity to the touch operation section, the pointer being displayed on the display section and being for selecting a content in the display object; and a scrolling executing section configured to continuously execute scrolling of the display object in a case where the pointer has reached an end of the display section by the moving operation.

In order to attain the above object, a method of controlling a mobile terminal in accordance with an aspect of the present invention is a method of controlling an information processing device including (i) a display section configured to display a partial region of a display object and (ii) a touch operation section configured to accept a touch operation in which an indicator is brought into contact with or brought closer to the touch operation section, the method including the steps of: moving a pointer in accordance with a moving operation which has been received by the touch operation section and in which the indicator is moved while being kept in contact with or in proximity to the touch operation section, the pointer being displayed on the display section and being for selecting a content in the display object; and continuously executing scrolling of the display object in a case where the pointer has reached an end of the display section by the moving operation.

### Advantageous Effects of Invention

An aspect of the present invention makes it possible to provide a user with a smooth operational feeling.

### BRIEF DESCRIPTION OF DRAWINGS

FIG. 1 is a block diagram illustrating a main configuration of a mobile terminal in accordance with an embodiment of the present invention.

FIG. 2 is a diagram illustrating an appearance of the mobile terminal illustrated in FIG. 1.

FIG. 3 is a diagram illustrating an outline of how the mobile terminal illustrated in FIG. 1 operates in an embodiment of the present invention.

FIG. 4 is a flowchart illustrating an example of a flow of processes to be executed by the mobile terminal illustrated in FIG. 1.

FIG. 5 is a flowchart illustrating an example of a flow of an automatic scrolling process illustrated in FIG. 4.

FIG. 6 is a diagram illustrating how a content is selected in Embodiment 2.

FIG. 7 is a diagram illustrating how a content is selected in Embodiment 3.

FIG. 8 is a diagram illustrating how a content is selected in Embodiment 4.

### DESCRIPTION OF EMBODIMENTS

### Embodiment 1

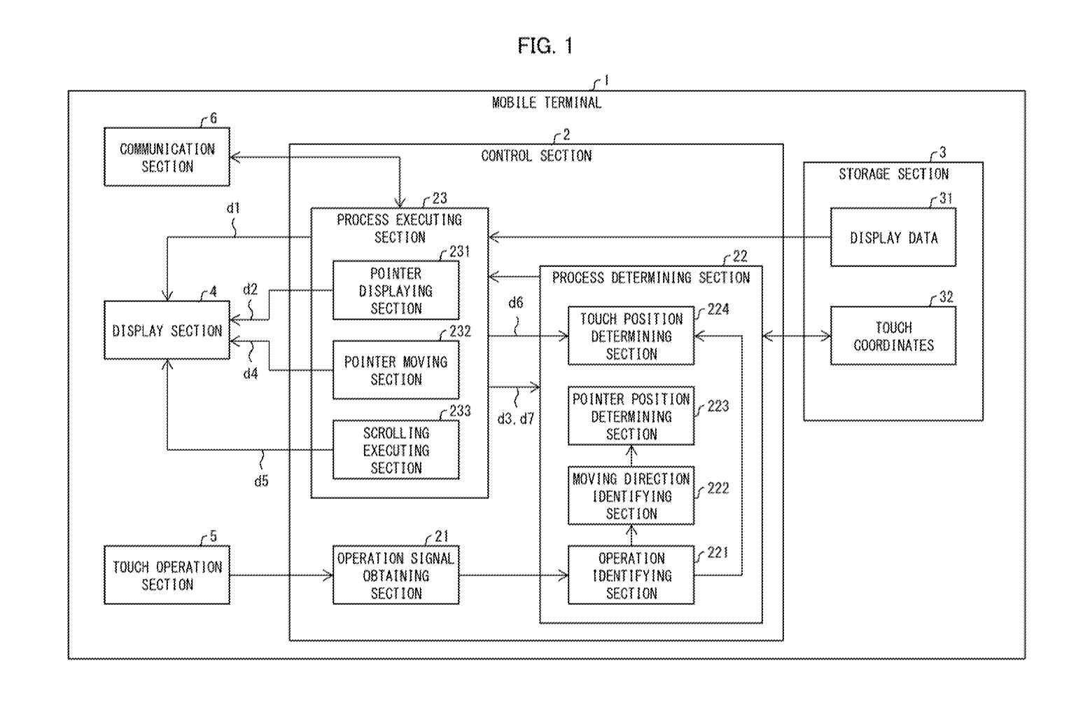

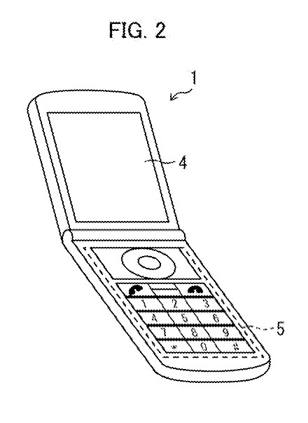

The following description will specifically discuss Embodiment 1 of the present invention with reference to FIGS. 1 through 5. First, an appearance configuration of a mobile terminal 1 (information processing device) in accordance with Embodiment 1 will be discussed with reference to FIG. 2. FIG. 2 is a diagram illustrating an appearance of the mobile terminal 1.

(Appearance Configuration of Mobile Terminal 1)

As illustrated in FIG. 2, the mobile terminal 1 is a so-called mobile phone having a speech communication function, and includes a display section 4 and a touch operation section 5. The mobile terminal 1 is constituted by two housings (hereinafter referred to as a first housing and a second housing) which are connected to each other and each of which has a substantially-flat plate shape (see FIG. 2). The display section 4 is provided on a surface (i.e., the broadest surface in FIG. 2) of the first housing, and hardware keys are provided on a surface (i.e., the broadest surface illustrated in FIG. 2) of the second housing. Beneath the hardware keys (i.e., inside the second housing), a sensor for the touch operation section 5 is provided such that the sensor overlaps the hardware keys. The mobile terminal 1 is configured to be transformable between an opened state (i.e., the state illustrated in FIG. 2) and a closed state (not illustrated). The opened state refers to a state in which the first housing and the second housing are making contact with each other only at their connection. The closed state refers to a state in which the surface (i.e., display surface) of the first housing on which surface the display section 4 is provided is facing the surface (i.e., operation surface) of the second housing on which surface the hardware keys are provided.

The display section 4 displays a display object in its display region. Examples of the display object include, but not limited to, a web page, a photograph, and a screen that is displayed as a result of execution of an application. The display section 4 can be, for example, a liquid crystal display (LCD) or an organic EL display.

The hardware keys are physical keys for allowing a user to operate the mobile terminal 1. The hardware keys output a signal corresponding to a key pressed by the user. Specific examples of the hardware keys include, but not limited to, numeric keys, a moving key, and a determination key. The numeric keys are hardware keys for inputting, for example, a phone number of a called party. The moving key is a hardware key for moving a cursor between a plurality of options (e.g., application icons) displayed on the display section 4. The determination key is a hardware key for selecting an option on which the cursor is displayed.

The touch operation section 5 is an input device for allowing the user to operate the mobile terminal 1. The touch operation section 5 includes the sensor. The touch operation section 5 detects, at given time intervals, an object (e.g., an indicator, a user's finger, or a stylus) that is in contact with the touch operation section 5, and outputs touch position information indicative of a position (i.e., touch position; e.g., two-dimensional coordinates on the touch operation section 5) at which the object has been detected. The touch position information is outputted together with information (hereinafter referred to as touch-down information) indicative of the contact of the object. In a case where the object has been detached from the touch operation section 5, the touch operation section 5 outputs information (hereinafter referred to as touch-up information) indicative of the detachment of the object. Hereinafter, contact of an object with the touch operation section 5 will sometimes be referred to as a touch-down, and detachment of an object from the touch operation section 5 will sometimes be referred to as a touch-up.

A detection region, in which the touch operation section 5 in accordance with Embodiment 1 detects contact of an object, extends over the entirety of the surface (i.e., operation surface) of the second housing on which surface the hardware keys are provided. That is, the operation surface of the second housing serves as a detection surface of the touch operation section 5. Examples of the sensor of the touch operation section 5 include, but not limited to, an electrostatic capacitive sensor. The sensor can alternatively be configured to detect, at given time intervals, an object that is in proximity to the touch operation section 5. That is, the touch operation section 5 is an input device for accepting a touch operation in which an indicator is brought into contact with or brought closer to the touch operation section 5.

Although the description herein discusses an example where the information processing device in accordance with an embodiment of the present invention is the mobile terminal 1 that is a so-called foldable mobile phone, application examples of the present invention are not limited to the mobile terminal 1. The present invention can also be applied to, for example, a bar mobile phone, a slider mobile phone, or a biaxial hinge mobile phone. Other than such mobile phones, the present invention can also be applied to various information processing devices each of which includes (i) a display section for displaying a display object and (ii) a touch operation section for accepting a touch operation carried out by a user. Typical examples of such information processing devices include a laptop computer, a portable game machine, a digital camera, a digital video camera, a portable music player, a smartphone, and a tablet terminal.

(Outline of How Mobile Terminal 1 Operates)

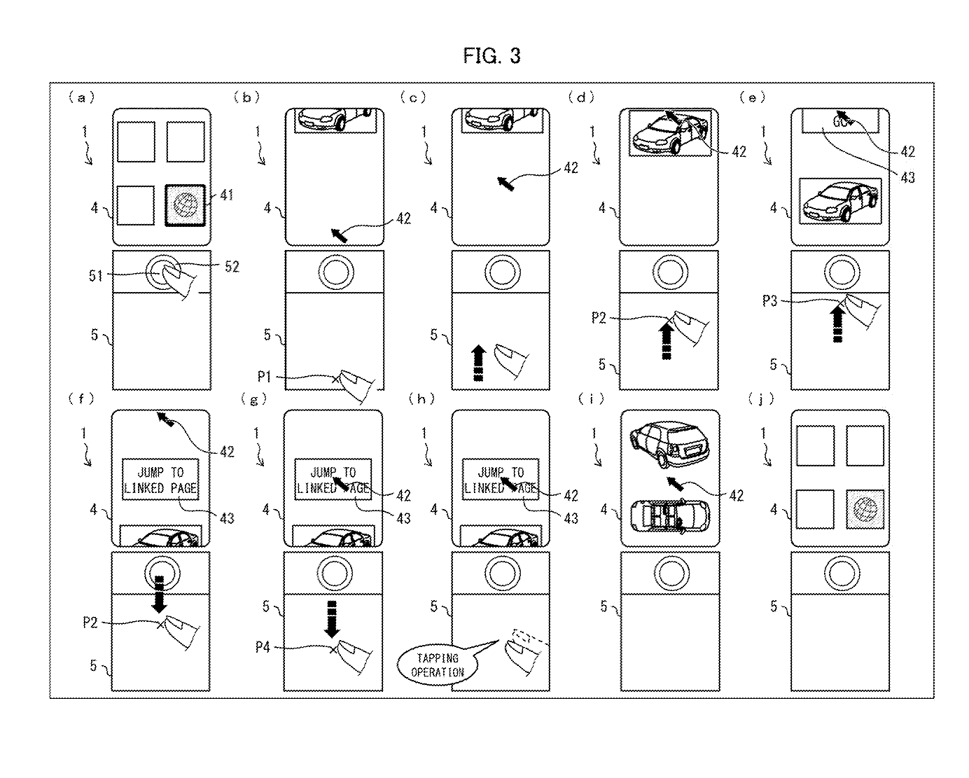

Next, the following description will discuss, with reference to FIG. 3, an outline of how the mobile terminal 1 operates. FIG. 3 is a transition diagram illustrating the outline of how the mobile terminal 1 operates. Note that, in regard to the mobile terminal 1 illustrated in FIG. 3, a display section 4 side will be referred to as an upper side of the mobile terminal 1, and a touch operation section 5 side will be referred to as a lower side of the mobile terminal 1.

First, in a state in which a menu screen illustrated in (a) of FIG. 3 is displayed on the display section 4, a user operates a moving key 52. In accordance with the operation, the mobile terminal 1 moves a cursor that is displayed while being superimposed on an icon displayed on the display section 4. Then, in a state in which the cursor is displayed on an icon (in the illustrated example, an icon 41 of an application for launching a browser) that the user wishes to select, the user presses a determination key 51 (see (a) of FIG. 3). In response to this operation, the mobile terminal 1 causes the display section 4 to display a browser. Note that the icon 41 can also be expressed as an icon of an application for browsing a web page.

The user operates the mobile terminal 1 so as to cause a desired web page (i.e., display object) to be displayed on the browser (in other words, on the display section 4 on which the browser is displayed). In a case where the web page is larger than the display region of the display section 4, the display section 4 displays only a part of the web page (i.e., a partial region of the display object). In Embodiment 1, the mobile terminal 1 deforms the web page so that shorter sides of the web page respectively conform in length to those of the display region of the display section 4, and causes the display section 4 to display the web page thus deformed. That is, in a case where the user browses a part of the web page which part is not displayed on the display section 4, the user only needs to scroll the web page in a direction (i.e., vertical direction) in which longer sides of the display region of the display section 4 extend.

Subsequently, in a state in which the web page is displayed on the display section 4, the user carries out a touch-down by bringing an indicator (in the illustrated example, a user's finger) into contact with a certain position (in the illustrated example, a position P1) of the touch operation section 5 (see (b) of FIG. 3). Upon detection of the touch-down, the mobile terminal 1 causes the display section 4 to display a pointer 42. Note that, in the display region of the display section 4, the pointer 42 is displayed at a position corresponding to the position (in the illustrated example, the position P1) at which the touch-down has been carried out with respect to the touch operation section 5. Note also that the mobile terminal 1 can be configured to hide the pointer 42 upon detection of a touch-up. The pointer 42 is a pointer for selecting a content in the display object. More preferably, the pointer 42 is a pointer for selecting, in a state in which none of contents in the display object is selected, any of the contents in the display object.

Subsequently, in a case where the user carries out a sliding operation (i.e., moving operation) in which the indicator is moved while being kept in contact with the touch operation section 5, the mobile terminal 1 moves the pointer 42 in a direction corresponding to a direction of the sliding operation (see (c) of FIG. 3). In the illustrated example, the pointer 42 is moved in an upward direction in response to an upward sliding operation. Note that an association between the direction of the sliding operation and the moving direction of the pointer 42 is not limited to the illustrated example.

In a case where the user continues the sliding operation in one direction (in the illustrated example, in the upward direction), the pointer 42 reaches an end of the display region (in the illustrated example, an upper end of the display region) of the display section 4 (see (d) of FIG. 3). Note that a position on the touch operation section 5 at which position the indicator is located when the pointer 42 reaches the end of the display region is referred to as a position P2. In a case where the pointer 42 has reached an end of the display region, the mobile terminal 1 starts automatic scrolling of the web page in a direction corresponding to the direction of the sliding operation (see (e) of FIG. 3). The “automatic scrolling” refers to a state in which scrolling of the web page continues without a continuous operation (e.g., sliding operation) for scrolling the web page. That is, after the automatic scrolling is started, the user can continue scrolling of the web page without carrying out any further operation with respect to the touch operation section 5 or to the hardware keys. In the illustrated example, the automatic scrolling is executed in a direction from the lower end to the upper end of the display section 4 in response to the upward sliding operation. However, the direction of the automatic scrolling is not limited to this example.

In a case where the user continues, after the automatic scrolling is started, the sliding operation without changing the direction of the sliding operation, the mobile terminal 1 increases a velocity of automatic scrolling. For example, in a case where the user has carried out an upward sliding operation so as to move the indicator to a position P3 on the touch operation section 5, the mobile terminal 1 increases the velocity of automatic scrolling (see (e) of FIG. 3).

Subsequently, in a case where the user has changed the direction of the sliding operation into an opposite direction (i.e., downward direction), the mobile terminal 1 reduces the velocity of automatic scrolling. For example, in a case where the position of the indicator is moved from the position P3 to the position P2 by a sliding operation, the mobile terminal 1 reduces the velocity of automatic scrolling as the position of the indicator comes closer to the position

P2 (see (f) of FIG. 3). In a case where the indicator has reached the position P2, the mobile terminal 1 terminates automatic scrolling.

Subsequently, in a case where the user has continued the sliding operation after termination of automatic scrolling, the mobile terminal 1 moves the pointer 42 in a direction corresponding to a direction of the sliding operation. For example, in a case where the user has carried out a downward sliding operation, the mobile terminal 1 moves the pointer 42 in the downward direction (see (g) of FIG. 3). In the illustrated example, the user continues the downward sliding operation to a position P4 so as to bring the position of the pointer 42 to a selectable content 43 (i.e., a content in the display object; a rectangle in which “JUMP TO LINKED PAGE” is written). In other words, the user superimposes the pointer 42 on the selectable content 43. Note that the selectable content refers to a content for which a given process is executed in a case where the content has been selected by an operation (user operation) that the user carries out with respect to the touch operation section 5 or to the hardware keys.

Subsequently, the user carries out a tapping operation with respect to the touch operation section 5 while the pointer 42 is located on the selectable content 43 (see (h) of FIG. 3). This causes the display section 4 to display a web page linked to the selectable content 43 (see (i) of FIG. 3). The tapping operation refers to an operation in which an indicator is brought into contact with the touch operation section 5 and then detached from the touch operation section 5 within a given period of time from when the contact was made. In the illustrated example, the user is touching the touch operation section 5 by the finger. Therefore, the user detaches the finger from the touch operation section 5 first, and then carries out the tapping operation.

Lastly, in a case where the application has been terminated by a given user operation, the display section 4 terminates display of the browser, and displays the menu screen (see (j) of FIG. 3). In this case, display of the pointer 42 is also terminated, and therefore the user can neither move the pointer 42 nor carry out the automatic scrolling even by carrying out the foregoing sliding operation.

As described above, by carrying out a series of operations without detaching the finger from the touch operation section 5, the user of the mobile terminal 1 in accordance with Embodiment 1 can cause the mobile terminal 1 to move the pointer 42 and to execute scrolling of the web page. Therefore, in a case where no selectable content 43 is displayed on the display section 4 (in other words, in a case where it is necessary to scroll the web page so as to cause the selectable content 43 to be displayed), the user can smoothly carry out display and selection of the selectable content 43.

(Main Configuration of Mobile Terminal 1)

Next, the following description will discuss, with reference to FIG. 1, a main configuration of the mobile terminal 1 for executing the foregoing operations. FIG. 1 is a block diagram illustrating an example of the main configuration of the mobile terminal 1. The mobile terminal 1 includes a control section 2, a storage section 3, the display section 4, the touch operation section 5, and a communication section 6. The control section 2 collectively controls sections provided in the mobile terminal 1. The storage section 3 stores various types of data to be used in the mobile terminal 1. The communication section 6 transmits and receives information (e.g., receives a web page) via the Internet.

As illustrated in FIG. 1, the control section 2 includes an operation signal obtaining section 21, a process determining section 22, and a process executing section 23. The storage section 3 stores at least (i) display data 31 for displaying, for example, a menu screen, a browser, and the pointer 42, and (ii) touch coordinates 32 indicative of a position where a touch operation is carried out with respect to the touch operation section 5.

The operation signal obtaining section 21 obtains an operation signal from the touch operation section 5. Specifically, in a case where a touch-down has been carried out with respect to the touch operation section 5, the operation signal obtaining section 21 obtains, from the touch operation section 5, (i) touch-down information and (ii) touch position information (i.e., coordinates on an x-y plane that is virtually set on the touch operation section 5) indicative of the position where the touch-down has been carried out. Note that Embodiment 1 is given on the assumption that, in FIG. 3, (i) an axis parallel to the shorter sides of the touch operation section 5 is an x-axis, (ii) an axis parallel to the longer sides of the touch operation section 5 is a y-axis, and (iii) a vertex at a lower left corner of the touch operation section 5 is the origin (i.e., a point where the coordinates are (x,y)=(0,0)) of the x-y plane. In a case where a touch-up has been carried out with respect to the touch operation section 5, the operation signal obtaining section 21 obtains touch-up information from the touch operation section 5. The operation signal obtaining section 21 supplies the information thus obtained to the process determining section (specifically, to an operation identifying section 221 discussed later). Note that the touch position information only needs to be information based on which a touch-down position on the touch operation section 5 can be identified, and is not limited to the foregoing coordinates. Although not illustrated, the operation signal obtaining section 21 also obtains an operation signal from the hardware keys, and supplies the operation signal to the process determining section 22.

The process determining section 22 determines details of a display process to be executed in the mobile terminal 1, and supplies, to the process executing section 23, an instruction on executing the display process thus determined. Specifically, every time the process executing section 23 executes a display process, the process determining section 22 obtains, from the process executing section 23, display information (i.e., d3 in FIG. 1) indicative of a content that is currently displayed on the display section 4. This allows the process determining section 22 to grasp a latest displayed content. In a case where, for example, the menu screen is displayed on the display section 4, the process determining section 22 can identify, based on the display information, positions of respective icons and a position of the cursor in the display region of the display section 4. Further, the process determining section 22 determines, based on the obtained display information and information obtained from the operation signal obtaining section 21, details of a display process to be executed in the mobile terminal 1.

More specifically, the process determining section 22 determines details of a display process based on (i) an operation signal indicating that the hardware keys have been operated and (ii) latest display information, and gives an instruction to the process executing section 23. For example, in a case where the latest display information indicates that the cursor is on the icon 41 when the process determining section 22 has obtained an operation signal indicative of pressing of the determination key (see (a) of FIG. 3), the process determining section 22 instructs the process executing section 23 to launch an application so that a browser is displayed on the display section 4.

Furthermore, the process determining section 22 determines details of a display process based on a user operation that is carried out with respect to the touch operation section 5, and gives, to the process executing section 23, an instruction on executing the display process thus determined. Specific examples of this operation will be discussed later. The process determining section 22 includes the operation identifying section 221, a moving direction identifying section 222, a pointer position determining section 223, and a touch position determining section 224.

The operation identifying section 221 identifies a user operation carried out with respect to the touch operation section 5. Specifically, the operation identifying section 221 identifies a type of the user operation based on information obtained from the touch operation section 5. For example, upon obtainment of touch-down information and touch position information, the operation identifying section 221 identifies a touch-down carried out with respect to the touch operation section 5. For example, upon obtainment of touch-up information, the operation identifying section 221 identifies a touch-up carried out with respect to the touch operation section 5.

Furthermore, the operation identifying section 221 identifies a type of the user operation based on a touch-down and a touch-up that are successively carried out with respect to the touch operation section 5. For example, in a case where the operation identifying section 221 has identified a touch-down and then identified a touch-up within a given period of time from when the touch-down was identified, the operation identifying section 221 identifies, as a tapping operation, the user operation carried out with respect to the touch operation section 5. For example, in a case where the operation identifying section 221 has identified a touch-down and then, without identifying a touch-up, identified another touch-down, the operation identifying section 221 identifies, as a sliding operation, the user operation carried out with respect to the touch operation section 5. Note that the above case where the operation identifying section 221 identifies a touch-down and then, without identifying a touch-up, identifies another touch-down is a case where the operation identifying section 221 obtains new touch-down information and touch position information that differs from previously-obtained touch position information. In a case where the user operation has been identified as a sliding operation, the operation identifying section 221 (i) supplies, to the moving direction identifying section 222, pieces of touch position information in the order that the pieces of touch position information have been successively obtained, and also (ii) supplies latest touch position information to the touch position determining section 224. In a case where the user operation has been identified as a tapping operation, the operation identifying section 221 notifies the pointer position determining section 223 of the operation thus identified. Note that the above examples of identifying the user operation are illustrative only, and the user operation to be identified by the operation identifying section 221 is not limited to such examples.

The moving direction identifying section 222 identifies a direction of a sliding operation. Specifically, upon receipt, from the operation identifying section 221, of pieces of touch position information that have been successively obtained by the operation identifying section 221, the moving direction identifying section 222 identifies the direction of the sliding operation based on a magnitude relationship among x-coordinates and y-coordinates of the two pieces of touch position information. In a case where, for example, the two pieces of touch position information have the same x-coordinate and the y-coordinate of a secondly-obtained one of the two pieces of touch position information is greater in value than that of a firstly-obtained one of the two pieces of touch position information, the moving direction identifying section 222 identifies the moving direction of the sliding operation as the upward direction. The moving direction identifying section 222 supplies, to the pointer position determining section 223, information indicative of the moving direction of the sliding operation thus identified.

The pointer position determining section 223 identifies, based on latest display information, pointer position information indicative of a current position of the pointer 42 on the display section 4, and determines whether the position indicated by the pointer position information satisfies a given condition. Specifically, in order to determine whether to start automatic scrolling, the pointer position determining section 223 determines whether the position indicated by the pointer position information thus identified has reached an end of the display region. In Embodiment 1, the pointer position information is coordinates on the x-y plane that is virtually set in the display region of the display section 4. However, the pointer position information only needs to be information that allows identification of the position of the pointer 42 in the display region, and is not limited to the above coordinates. Embodiment 1 is given on the assumption that, in FIG. 3, (i) an axis parallel to the shorter sides of the display section 4 is the x-axis, (ii) an axis parallel to the longer sides of the display section 4 is the y-axis, and (iii) a vertex at a lower left corner of the display section 4 is the origin (i.e., a point where the coordinates are (x,y)=(0,0)) of the x-y plane.

As discussed earlier, the mobile terminal 1 in accordance with Embodiment 1 is configured to start vertical scrolling in a case where the pointer 42 has reached the upper end or the lower end of the display region of the display section 4 illustrated in FIG. 3. Therefore, the pointer position determining section 223 only needs to be capable of determining whether or not the position indicated by the pointer position information is located at the upper end or the lower end of the display region of the display section 4. That is, upon receipt of pointer position information from the process executing section 23, the pointer position determining section 223 in accordance with Embodiment 1 determines whether a y-coordinate of the pointer position information is a y-coordinate indicative of an end of the display region of the display section 4. In a case where the pointer position determining section 223 in accordance with

Embodiment 1 has determined that the position indicated by the pointer position information is located at the upper end or the lower end of the display region of the display section 4, the pointer position determining section 223 identifies whether the position is located at the upper end of the display region of the display section 4 or at the lower end of the display region of the display section 4.

Upon receipt, from the operation identifying section 221, a notification that a tapping operation has been identified, the pointer position determining section 223 determines whether the position indicated by the pointer position information is located within a range in which the selectable content 43 is displayed. In order to carry out this determination, upon receipt of the notification, the pointer position determining section 223 identifies, based on latest display information, information indicative of the range in which the selectable content 43 is displayed.

The touch position determining section 224 determines whether the position which is indicated by the touch position information and is on the touch operation section 5 satisfies a given condition for terminating automatic scrolling. Specifically, the touch position determining section 224 obtains, from the operation identifying section 221, (i) information indicative of the sliding operation and (ii) latest touch position information. In a case where the process determining section 22 has been instructed to carry out a determination, the touch position determining section 224 determines whether the y-coordinate of the latest touch position information matches the y-coordinate of the touch coordinates 32 stored in the storage section 3.

Note that the storage section 3 stores, as the touch coordinates 32, at least two sets of coordinates, namely, (i) coordinates indicative of a position of a touch-down in response to which the pointer 42 has been displayed and (ii) coordinates indicative of a position of a touch-down in response to which automatic scrolling has been started. Hereinafter, the coordinates indicative of the position of the touch-down in response to which the pointer 42 has been displayed will sometimes be referred to as coordinates (x1,y1). Similarly, the coordinates indicative of the position of the touch-down in response to which automatic scrolling has been started will sometimes be referred to as coordinates (x2,y2). The touch position determining section 224 obtains, from the process executing section 23, (i) information indicative of a current velocity of automatic scrolling and (ii) information indicative of a given initial velocity v0 (these pieces of information will be hereinafter collectively referred to as velocity information) (see d6 of FIG. 1), and determines a magnitude relationship between the velocities indicated by the two pieces of information.

In a case where the touch position determining section 224 has determined that the current velocity of automatic scrolling is higher than the initial velocity v0, the touch position determining section 224 reads out the coordinates (x2,y2) from the touch coordinates 32, and further determines whether the y-coordinate of the latest touch position information matches a value of the coordinate y2. In contrast, in a case where the touch position determining section 224 has determined that the current velocity of automatic scrolling is not higher than the initial velocity v0, the touch position determining section 224 reads out the coordinates (x1,y1) from the touch coordinates 32, and further determines whether the y-coordinate of the latest touch position information matches a value of the coordinate y 1. Note that the above case where the current velocity of automatic scrolling is not higher than the initial velocity v0 can also be expressed as a case where the current velocity of automatic scrolling is equal to or lower than the initial velocity v0.

(Specific Examples of How Details of Display Process are Determined Based on User Operation Carried Out with Respect to Touch Operation Section 5)

Next, the following description will discuss specific examples of how the process determining section 22 determines details of a display process based on a user operation carried out with respect to the touch operation section 5. Discussed first is a case where latest display information indicates that a browser is displayed on the display section 4 and the pointer 42 is not displayed on the display section 4.

In a case where, in such a state, the operation identifying section 221 has identified the user operation as a touch-down, the process determining section 22 supplies obtained touch position information to the process executing section 23 so as to instruct the process executing section 23 to cause the pointer 42 to be displayed. Furthermore, the process determining section 22 causes the storage section 3 to store the obtained touch position information as the touch coordinates 32 (more specifically, as the foregoing coordinates (x1,y1)).

Discussed next is a case where latest display information indicates that a browser and the pointer 42 are displayed on the display section 4.

In such a state, in a case where (i) the operation identifying section 221 has identified the user operation as a sliding operation and (ii) the pointer position determining section 223 has determined that the pointer 42 has not reached an end of the display region of the display section 4 (see (c) of FIG. 3), the process determining section 22 supplies obtained latest touch position information to the process executing section 23 so as to instruct the process executing section 23 to move the pointer 42 on the display section 4.

In contrast, in a case where (i) the operation identifying section 221 has identified the user operation as a sliding operation and (ii) the pointer position determining section 223 has determined that the pointer 42 has reached an end (e.g., upper end) of the display region of the display section 4, the process determining section 22 checks whether the process executing section 23 is executing automatic scrolling (see d7 of FIG. 1). In a case where automatic scrolling is not being executed, the process determining section 22 instructs the process executing section 23 to execute automatic scrolling in a direction corresponding to a direction of the sliding operation identified by the moving direction identifying section 222. For example, in a case where the moving direction identifying section 222 has identified the moving direction of the sliding operation as the upward direction (see (d) of FIG. 3), the process determining section 22 instructs the process executing section 23 to execute automatic scrolling in the direction from the lower end to the upper end of the display section 4. In such a case, the process determining section 22 causes the storage section 3 to store latest touch position information at this point in time (in other words, touch position information obtained when the pointer 42 has reached the end of the display region of the display section 4) as the touch coordinates 32 (more specifically, as the foregoing coordinates (x2,y2)).

Discussed next is a case where the process executing section 23 is executing automatic scrolling. In a case where the moving direction identifying section 222 has identified a direction of the sliding operation as a direction (i.e., outward direction) toward the outer side of the operation surface of the touch operation section 5, the process determining section 22 identifies a moving distance of the sliding operation, and instructs the process executing section 23 to increase the velocity of automatic scrolling in accordance with the moving distance thus identified. Here, an example will be discussed where automatic scrolling is being executed in the direction from the lower end to the upper end of the display section 4 because the pointer 42 has been brought to the upper end of the display region by an upward sliding operation illustrated in FIG. 3. In this state of the example, in a case where the moving direction identifying section 222 further identifies another upward sliding operation, then the process determining section 22 instructs the process executing section 23 to increase the velocity of automatic scrolling in accordance with the moving distance of the another upward sliding operation thus identified.

In contrast, in a case where the moving direction identifying section 222 has identified a direction of the sliding operation as a direction (i.e., inward direction) toward the inner side of the operation surface of the touch operation section 5, the process determining section 22 causes the touch position determining section 224 to carry out the foregoing determination. In accordance with a result of determination carried out by the touch position determining section 224, the process determining section 22 reduces the velocity of automatic scrolling or terminates automatic scrolling.

Specifically, in a case where the touch position determining section 224 has determined that the y-coordinate of the latest touch position information matches neither the value of the coordinate yl of the coordinates (x1,y1) stored as the touch coordinates 32 nor the value of the coordinate y2 of the coordinates (x2,y2) stored as the touch coordinates 32, the process determining section 22 identifies a moving distance of the sliding operation, and instructs the process executing section 23 to reduce the velocity of automatic scrolling in accordance with the moving distance thus identified.

In contrast, in a case where the touch position determining section 224 has determined that the y-coordinate of the latest touch position information matches the value of the coordinate y1 of the coordinates (x1,y1) stored as the touch coordinates 32 or the value of the coordinate y2 of the coordinates (x2,y2) stored as the touch coordinates 32, the process determining section 22 instructs the process executing section 23 to terminate automatic scrolling. The position indicated by the latest touch position information in the above case can also be expressed as “a position identified based on the position where the indicator was located when automatic scrolling was started” or “a position identified based on the position where the indicator was located when the pointer was displayed on the display section 4”.

In a case where (i) the operation identifying section 221 has identified the user operation as a tapping operation and (ii) the pointer position determining section 223 has determined that the pointer 42 is located on the selectable content 43 (see (h) of FIG. 3), the process determining section 22 instructs the process executing section 23 to execute a display process corresponding to the selectable content 43 (e.g., display of a web page linked to the selectable content 43).

Note that the foregoing instructions from the process determining section 22 to the process executing section 23 are illustrative only, and the instruction to be supplied to the process executing section 23 is not limited to such examples.

The process executing section 23 executes a process in the mobile terminal 1, particularly a display process for the display section 4. The process executing section 23 includes a pointer displaying section 231, a pointer moving section 232, and a scrolling executing section 233. As discussed earlier, every time the process executing section 23 executes a display process, the process executing section 23 supplies, to the process determining section 22, display information (d3 in FIG. 1) indicative of a content that is currently displayed on the display section 4.

The pointer displaying section 231 causes, in accordance with an instruction from the process determining section 22, the display section 4 to display the pointer 42. Specifically, upon receipt, from the process determining section 22, of an instruction on displaying the pointer 42, the pointer displaying section 231 identifies a position in the display region of the display section 4 which position corresponds to a position indicated by touch position information that has been obtained together with the instruction. The pointer displaying section 231 then reads out the image data of the pointer 42 from the display data 31 stored in the storage section 3, and causes the pointer 42 to be displayed at the position thus identified (see d2 in FIG. 1). In other words, in a case where a touch operation is received, the pointer displaying section 231 causes the display section 4 to display the pointer 42 for selecting a content in the display object.

The pointer moving section 232 moves, on the display section 4, the pointer 42 displayed by the pointer displaying section 231. Specifically, upon receipt, from the process determining section 22, of an instruction on moving the pointer 42, the pointer displaying section 231 identifies a position in the display region of the display section 4 which position corresponds to the position indicated by touch position information that has been obtained together with the instruction. The pointer moving section 232 then moves the pointer 42 to the position thus identified (see d4 of FIG. 1). In other words, in a case where a sliding operation has been received in which the indicator is moved while being kept in contact with or in proximity to the touch operation section 5, the pointer moving section 232 moves the pointer 42 in accordance with the sliding operation. In other words, in a case where the touch operation section 5 has received, after termination of automatic scrolling, a sliding operation while the indicator is kept in contact with or in proximity to the touch operation section 5, the pointer moving section 232 moves the pointer 42 in accordance with the sliding operation.

The scrolling executing section 233 executes scrolling of a display object. Specifically, upon receipt, from the process determining section 22, of an instruction on executing automatic scrolling, the scrolling executing section 233 starts automatic scrolling in a direction (e.g., the direction from the lower end to the upper end of the display section 4) corresponding to a direction of a sliding operation indicated by the instruction (see d5 of FIG. 1). More specifically, the scrolling executing section 233 successively changes displayed ranges of a web page (i.e., each range of the web page which range is displayed on the display section 4) obtained via the communication section 6, such that automatic scrolling is executed at the given initial velocity v0. In other words, in a case where the pointer 42 has reached an end of the display section 4 by a sliding operation, the scrolling executing section 233 continuously scrolls a display object.

Upon receipt, from the process determining section 22, of an instruction on changing a current velocity of automatic scrolling, the scrolling executing section 233 identifies a velocity of automatic scrolling based on a moving distance of a sliding operation obtained together with the instruction, and changes the current velocity of automatic scrolling to the velocity thus identified. The instruction on changing the velocity of automatic scrolling is given in a case where the touch operation section 5 has received, after start of automatic scrolling of the display object, a sliding operation while the indicator is kept in contact with or in proximity to the touch operation section 5. Upon receipt of the instruction, the scrolling executing section 233 changes the velocity of automatic scrolling of the display object in accordance with a direction of the sliding operation.

Upon receipt, from the process determining section 22, of an instruction on terminating automatic scrolling, the scrolling executing section 233 terminates automatic scrolling. The instruction on terminating automatic scrolling is given in a case where the indicator has been moved to a position identified based on a position where the indicator was located when automatic scrolling was started. In this case, the indicator is moved by a further sliding operation that is carried out, following change of the scrolling velocity of the display object, while the indicator is kept in contact with or in proximity to the touch operation section 5. Upon receipt of the instruction, the scrolling executing section 233 terminates automatic scrolling. In other words, the instruction on terminating automatic scrolling is given in a case where the indicator has been moved, by a further sliding operation that is carried out while the indicator is kept in contact with or in proximity to the touch operation section 5, to a position that is identified based on a position where the indicator was located when the pointer 42 was displayed on the display section 4.

The process executing section 23 also executes, in accordance with an instruction from the process determining section 22, a display process other than the foregoing display processes. For example, upon receipt, from the process determining section 22, of an instruction for displaying a browser, the process executing section 23 reads out, from the display data 31 stored in the storage section 3, data for displaying the browser, and causes the display section 4 to display the browser (see d1 of FIG. 1). Upon receipt, from the process determining section 22, of an instruction on displaying a linked web page, the process executing section 23 obtains, via the communication section 6, information for displaying the web page, and causes the display section 4 to display the web page (see d1 of FIG. 1).

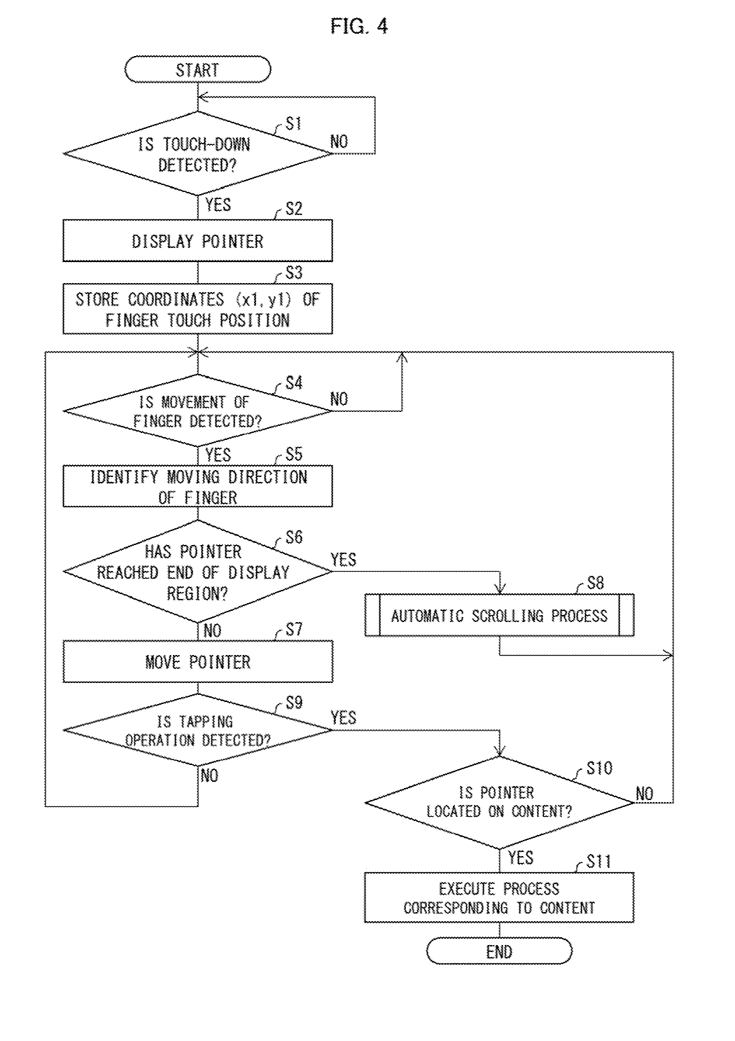

(Flow of processes to be executed by mobile terminal 1) Next, the following description will discuss, with reference to FIG. 4, a flow of processes to be executed by the mobile terminal 1. FIG. 4 is a flowchart illustrating an example of the flow of processes to be executed by the mobile terminal 1. Note that the flowchart in FIG. 4 illustrates processes to be executed after a browser and a web page are displayed.

First, the operation identifying section 221 is on standby to receive an operation signal from the operation signal obtaining section 21 (step S1, hereinafter “step” will be omitted). In a case where the operation identifying section 221 has detected a touch-down (YES in S1), the process determining section 22 supplies obtained touch position information to the process executing section 23 so as to instruct the process executing section 23 to cause the pointer 42 to be displayed. Note that detection of a touch-down is carried out by obtaining, from the operation signal obtaining section 21, (i) touch-down information and (ii) touch position information indicative of a position of the touch-down. Detection of a touch-down can also be expressed as a process in which the operation identifying section 221 identifies a user operation as a touch-down. The pointer displaying section 231 of the process executing section 23 identifies a position in the display region of the display section 4 which position corresponds to the position indicated by the obtained touch position information, and causes the pointer 42 to be displayed at the position thus identified (S2). The process determining section 22 causes the storage section 3 to store coordinates (x1,y1) of the finger touch position as the touch coordinates 32 (S3).

Subsequently, the operation identifying section 221 enters a state of waiting for movement of the finger on the touch operation section 5 (S4). In a case where the operation identifying section 221 has detected movement of the finger (in other words, in a case where the operation identifying section 221 identifies the user operation as a sliding operation) (YES in S4), the moving direction identifying section 222 identifies a moving direction of the finger (S5). Subsequently, the pointer position determining section 223 obtains pointer position information from the process executing section 23, and determines whether the pointer 42 has reached an end of the display region of the display section 4 (S6). In a case where the pointer position determining section 223 has determined that the pointer 42 has reached an end of the display region (YES in S6), the mobile terminal 1 executes an automatic scrolling process (S8). The automatic scrolling process will be discussed later in detail.

In contrast, in a case where the pointer position determining section 223 has determined that the pointer 42 has not reached an end of the display region (NO in S6), the process determining section 22 supplies obtained latest touch position information to the process executing section 23 so as to instruct the process executing section 23 to move the pointer 42 on the display section 4. The pointer moving section 232 of the process executing section 23 identifies a position in the display region of the display section 4 which position corresponds to a position indicated by the touch position information thus obtained. The pointer moving section 232 then moves the pointer 42 to the position thus identified (S7, pointer moving step).

Subsequently, the operation identifying section 221 enters a state of waiting for a tapping operation (S9). In a case where the operation identifying section 221 has detected a tapping operation (YES in S9), the pointer position determining section 223 determines, based on display information obtained from the process executing section 23, whether the pointer 42 is located on the selectable content 43 (S10). The detection, by the operation identifying section 221, of a tapping operation can also be expressed as a process in which the operation identifying section 221 identifies the user operation as a tapping operation. In a case where the pointer 42 is located on the selectable content 43 (YES in S10), the process determining section 22 instructs the process executing section 23 to execute a process corresponding to the selectable content 43. For example, the process determining section 22 instructs the process executing section 23 to cause a web page linked to the selectable content 43 to be displayed. The process executing section 23 then executes a process corresponding to the process determining section 22 (e.g., causes a web page linked to the selectable content 43 to be displayed) (S11). The process in the illustrated flowchart thus ends.

Note that the illustrated process returns to S4 when the automatic scrolling process is terminated. The illustrated process returns to S4 also in the case of NO in S4, in the case of NO in S9, and in the case of NO in S10. The case of NO in S4 is a case where no sliding operation is detected. The case of NO in S9 is a case where no tapping operation is detected. The case of NO in S10 is a case where the pointer is not located on the selectable content 43 when a tapping operation is detected.

(Flow of Automatic Scrolling Process)

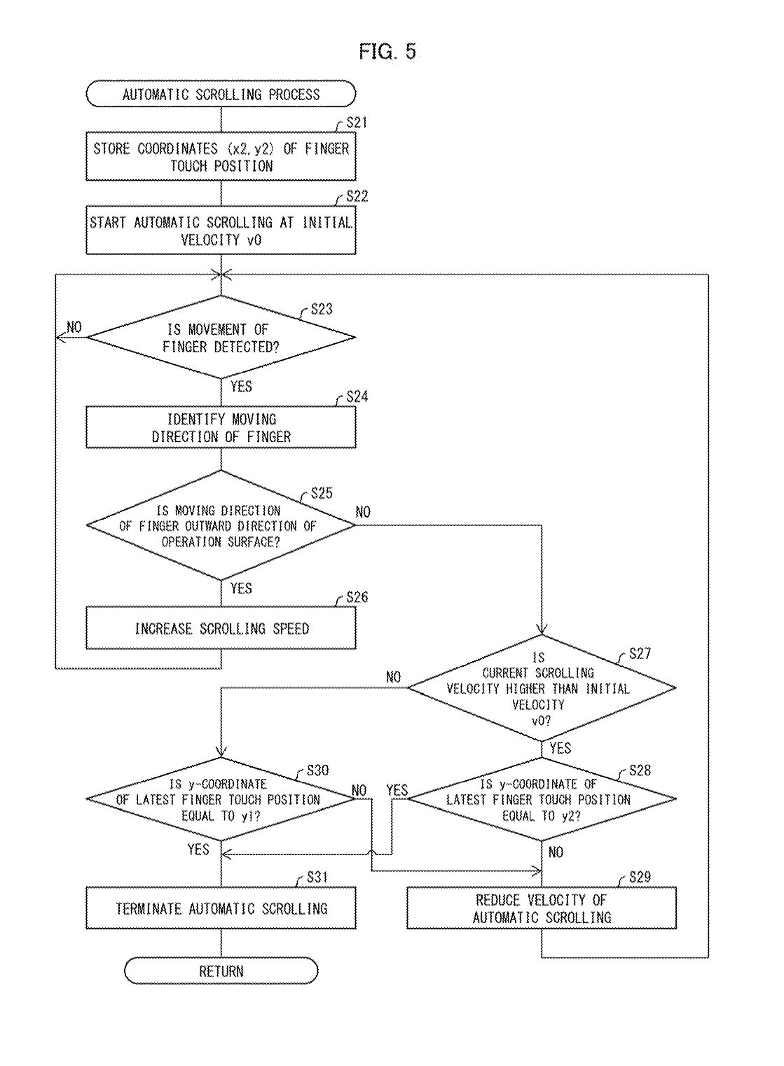

Next, the following description will discuss, with reference to FIG. 5, the flow of the automatic scrolling process illustrated in FIG. 4. FIG. 5 is a flowchart illustrating an example of the flow of the automatic scrolling process illustrated in FIG. 4.

First, in a case where the pointer position determining section 223 has determined that the pointer 42 has reached an end of the display region (YES in S6 in FIG. 4), the process determining section 22 instructs the process executing section 23 to execute automatic scrolling. Furthermore, the process determining section 22 causes the storage section 3 to store coordinates (x2,y2) of a finger touch position as the touch coordinates 32, the finger touch position being obtained when the pointer 42 reaches an end of the display region (S21). The scrolling executing section 233 of the process executing section 23 starts automatic scrolling at the initial velocity v0 and in a direction based on the instruction from the process determining section 22 (i.e., in a direction corresponding to a direction of the sliding operation identified by the moving direction identifying section 222) (S22, scrolling executing step).

Subsequently, the operation identifying section 221 enters a state of waiting for movement of the finger on the touch operation section 5 (S23). In a case where the operation identifying section 221 has detected movement of the finger (in other word, in a case where the operation identifying section 221 has identified the user operation as a sliding operation) (YES in S23), the moving direction identifying section 222 identifies a moving direction of the finger (S24).

Subsequently, the process determining section 22 determines whether the moving direction of the finger identified by the moving direction identifying section 222 is the outward direction of the operation surface of the touch operation section 5 (S25). In a case where the process determining section 22 has determined that the moving direction of the finger is the outward direction (YES in S25), the process determining section 22 instructs the process executing section 23 to increase a scrolling velocity of automatic scrolling. In accordance with the instruction, the process executing section 23 increases the scrolling velocity (S26). The automatic scrolling process then returns to S23.

In contrast, in a case where the process determining section 22 has determined that the moving direction of the finger is not the outward direction of the operation surface of the touch operation section 5 (NO in S25), the process determining section 22 instructs the touch position determining section 224 to carry out a determination. In accordance with the instruction from the process determining section 22, the touch position determining section 224 first determines, with reference to velocity information obtained from the process executing section 23, whether or not a current scrolling velocity is higher than the initial velocity v0 (S27). In a case where the touch position determining section 224 has determined that the current scrolling velocity is higher than the initial velocity v0 (YES in S27), the touch position determining section 224 further determines whether or not a y-coordinate of a latest finger touch position is equal to y2 (S28). In a case where the touch position determining section 224 has determined that the y-coordinate of the latest finger touch position is equal to y2 (YES in S28), the process determining section 22 instructs the process executing section 23 to terminate automatic scrolling. In accordance with the instruction, the process executing section 23 terminates automatic scrolling (S31). The automatic scrolling process thus ends. In contrast, in a case where the touch position determining section 224 has determined that the y-coordinate of the latest finger touch position is not equal to y2 (NO in S28), the process determining section 22 instructs the process executing section 23 to reduce the velocity of automatic scrolling. In accordance with the instruction, the process executing section 23 reduces the scrolling velocity (S29). The automatic scrolling process then returns to S23.

Meanwhile, in a case where the touch position determining section 224 has determined that the current scrolling velocity is not higher than the initial velocity v0 (NO in S27), the touch position determining section 224 further determines whether or not the y-coordinate of the latest finger touch position is equal to y1 (S30). In a case where the touch position determining section 224 has determined that the y-coordinate of the latest finger touch position is equal to y1 (YES in S30), the process determining section 22 instructs the process executing section 23 to terminate automatic scrolling. In accordance with the instruction, the process executing section 23 terminates automatic scrolling (S31). The automatic scrolling process thus ends. In contrast, in a case where the touch position determining section 224 has determined that the y-coordinate of the latest finger touch position is not equal to y1 (NO in S30), the process determining section 22 instructs the process executing section 23 to reduce the velocity of automatic scrolling. In accordance with the instruction, the process executing section 23 reduces the scrolling velocity (S29). The automatic scrolling process then returns to S23.

### Embodiment 2

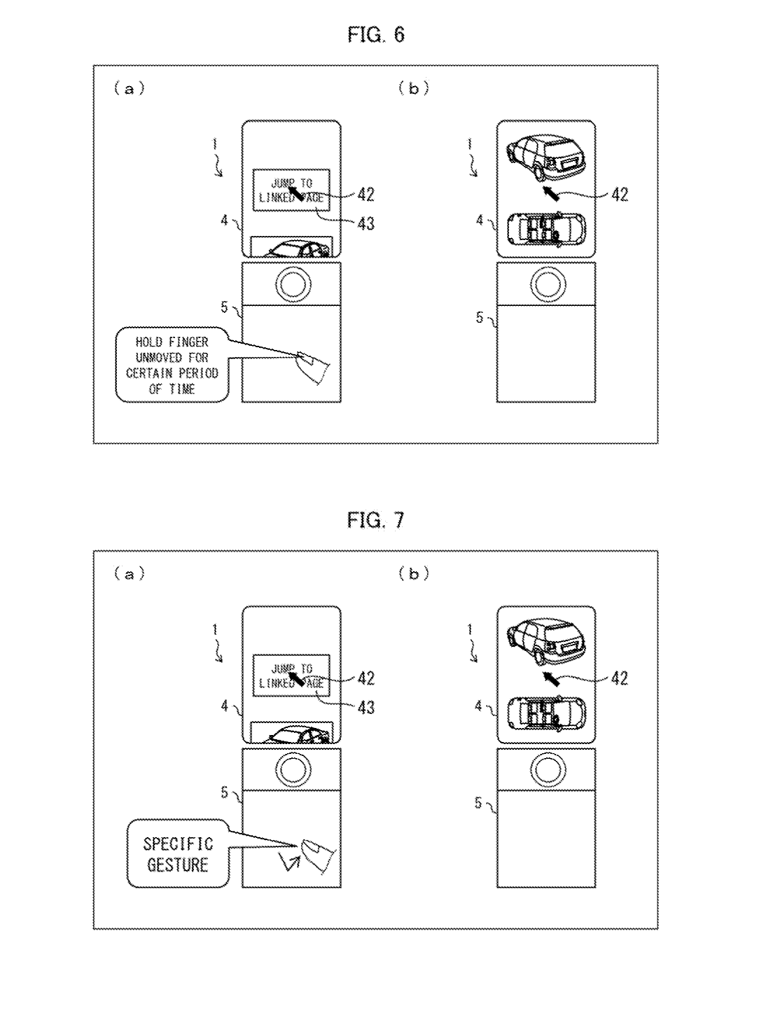

The following description will discuss Embodiment 2 of the present invention with reference to FIG. 6. FIG. 6 is a diagram illustrating how a selectable content 43 is selected in Embodiment 2. In this and subsequent embodiments, members having functions identical to those of members discussed in Embodiment 1 are, for convenience, given the same reference signs, and descriptions of such members are omitted.

Embodiment 1 is configured as follows: that is, in a case where the user has carried out a tapping operation with respect to the touch operation section 5 in a state in which the pointer 42 has been moved to a position on the selectable content 43, the selectable content 43 is selected and thereby a process corresponding to the selectable content 43 is executed. However, the user operation for selecting the selectable content 43 is not limited to such an example. For example, the following configuration can be employed: that is, in a case where the user moves the pointer 42 to a position on the selectable content 43 and then stops the finger for a certain period of time while the finger is kept in contact with or in proximity to the touch operation section 5 (see (a) of FIG. 6), the selectable content 43 is selected and thereby a web page linked to the selectable content 43 is displayed on a display section 4 (see (b) of FIG. 6).

Specifically, in a case where a period of time during which pieces of touch position information that indicate the same position are successively obtained exceeds a given period of time (not illustrated) stored in a storage section 3, a process determining section 22 instructs a process executing section 23 to execute a display process corresponding to the selectable content 43. In this case, measurement of time can be carried out with use of a timer (not illustrated) or the like.

### Embodiment 3

The following description will discuss Embodiment 3 of the present invention with reference to FIG. 7. FIG. 7 is a diagram illustrating how a selectable content 43 is selected in Embodiment 3.

A configuration can be employed in which the selectable content 43 is selected in a case where a user has moved a pointer 42 to a position on the selectable content 43 and makes a specific gesture on a touch operation section 5 while the finger is kept in contact with or in proximity to the touch operation section 5 (see (a) of FIG. 7). In the illustrated example, a web page linked to the selectable content 43 is displayed on a display section 4 in response to a sliding operation in which the user draws a checkmark on the touch operation section 5 (see (b) of FIG. 7).

Specifically, the process determining section 22 determines whether or not a difference between (i) a track of a gesture (not illustrated) stored in a storage section 3 and (ii) a track of an inputted gesture (in other words, a track drawn by successive pieces of touch position information) is smaller than a given value. In a case where the difference is smaller than the given value, a process determining section 22 instructs a process executing section 23 to execute a display process corresponding to the selectable content 43.

### Embodiment 4

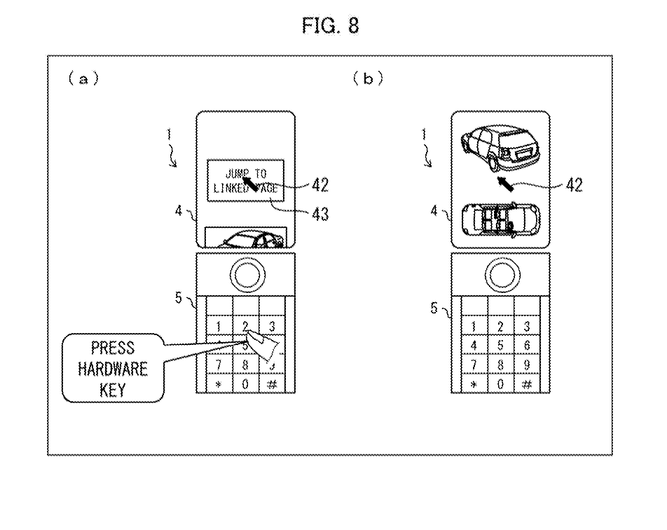

The following description will discuss Embodiment 4 of the present invention with reference to FIG. 8. FIG. 8 is a diagram illustrating how a selectable content 43 is selected in Embodiment 4.

A configuration can be employed in which the selectable content 43 is selected in a case where a user has pressed any one of hardware keys in a state in which a pointer 42 has been moved to a position on the selectable content 43 (see (a) of FIG. 8). In the illustrated example, a web page linked to the selectable content 43 is displayed on a display section 4 in response to pressing of a numeric key “5” (see (b) of FIG. 8). The key to be pressed is not limited to the illustrated example, and can alternatively be, for example, another numeric key, a determination key, or a moving key. In other words, Embodiment 4 employs a configuration in which the selectable content 43 is selected in a case where the user has pressed any key below the finger after the pointer 42 has been moved to a position on the selectable content 43.

Specifically, a process determining section 22 obtains information indicative of pressing of any of the hardware keys. In a case where display information indicates that the pointer 42 is on the selectable content 43, the process determining section 22 instructs a process executing section to execute a display process corresponding to the selectable content 43.

### MODIFICATION EXAMPLES

The foregoing embodiments (particularly, Embodiment 1) have discussed the example where automatic scrolling is executed in the direction (i.e., vertical direction) parallel to the longer sides of the display section 4 illustrated in FIG. 3 and the like. However, the direction of automatic scrolling is not limited to the vertical direction, and can alternatively be, for example, a direction (i.e., so-called horizontal direction) parallel to the shorter sides of the display section 4 illustrated in FIG. 3 and the like. In a case where the direction of automatic scrolling is the horizontal direction, it is preferable that a direction of a sliding operation for starting automatic scrolling (in other words, a sliding operation for causing the pointer 42 to reach an end of the display region of the display section 4) is also the horizontal direction.

In this example, the process determining section 22 is preferably configured to determine, when determining whether to terminate automatic scrolling, whether or not the x-coordinate of latest touch position information matches the coordinate x1 or x2. In such a case, the pointer position determining section 223 only needs to be capable of determining whether or not a position indicated by pointer position information is at the left end or the right end of the display region of the display section 4. In a case where the pointer position determining section 223 has determined that the position indicated by the pointer position information is at the left end or the right end of the display region of the display section 4, the pointer position determining section 223 preferably identifies whether the position is at the left end or at the right end of the display region of the display section 4.

Embodiment 1 has discussed the example where the velocity of automatic scrolling is changed with a degree corresponding to a moving distance of a sliding operation. However, the velocity of automatic scrolling can alternatively be changed with a degree corresponding to a velocity of a sliding operation. In this example, the touch operation section 5 supplies, to the operation signal obtaining section 21, (i) touch position information and (ii) touch time information indicative of the time at which a touch-down was carried out. In this case, the process determining section 22 identifies, based on (i) touch time information obtained when a sliding operation was started and (ii) touch time information obtained when the sliding operation was finished, a period of time during which the sliding operation was carried out, then divides a moving distance of the sliding operation by the period of time thus identified, and thus identifies a velocity of the sliding operation.

The velocity of automatic scrolling can be sequentially or gradually changed in accordance with a moving distance and/or a velocity of a sliding operation. In a case where a configuration is employed in which the velocity of automatic scrolling is gradually changed, the mobile terminal 1 causes the storage section 3 to store a table in which a plurality of numerical ranges each indicative of a moving distance or a velocity of a sliding operation are each associated with a numerical value indicative of a velocity of automatic scrolling. In this case, the process executing section 23 identifies corresponding one(s) of the plurality of numerical ranges in the table within which one(s) a moving distance and/or a velocity of a sliding operation fall(s), and thus identifies the velocity of automatic scrolling.

Embodiment 1 has discussed the example in which, in a case where a scrolling velocity has been reduced from the initial velocity v0 and the automatic scrolling is to be terminated, the user needs to move the indicator to a position whose y-coordinate matches that of a position of a touch-down in response to which the pointer 42 was displayed. However, the position to which the pointer 42 is moved for termination of automatic scrolling is not limited to such an example. For example, a configuration can be employed in which automatic scrolling is terminated in a case where the indicator has been moved to a position whose y-coordinate (or x-coordinate) matches that of a position of a touch-down in response to which the automatic scrolling was started. Alternatively, a configuration can be employed in which automatic scrolling is terminated, regardless of the scrolling velocity, in a case where the indicator has been moved to a position whose y-coordinate (or x-coordinate) matches that of a position of a touch-down in response to which the pointer 42 was displayed.

Further alternatively, a configuration can be employed in which automatic scrolling is terminated in a case where the indicator has been moved in the inward direction of the operation surface of the touch operation section 5, regardless of a position to which the indicator has been moved. Such a configuration can also be expressed as a configuration in which automatic scrolling is terminated in a case where a further sliding operation continuous with the sliding operation has been carried out in a direction opposite to that of the sliding operation, by which the pointer 42 was caused to reach an end of the display section 4, while the indicator is kept in contact with or in proximity to the touch operation section 5.

The mobile terminal 1 in accordance with each of the foregoing embodiments is not essentially configured such that the scrolling velocity is changed by a further sliding operation that is carried out after start of automatic scrolling. That is, the scrolling velocity can be fixed in the mobile terminal 1. The mobile terminal 1 can also be configured such that whether to change the scrolling velocity is determined based on the direction of automatic scrolling. Specifically, a configuration can be employed in which, in a case where automatic scrolling is executed in a direction (i.e., vertical direction) parallel to the longer sides of the display section 4 illustrated in FIG. 3 and the like, the scrolling velocity is changed in response to a further sliding operation that is carried out in the vertical direction after start of the automatic scrolling. In such a case, a configuration can be employed in which the scrolling velocity is not changed in response to a further sliding operation that is carried out in a direction (i.e., horizontal direction) parallel to the shorter sides of the display section 4 illustrated in FIG. 3 and the like. Furthermore, a configuration can be employed in which, in a case where automatic scrolling is executed in the horizontal direction, the scrolling velocity is changed in response to a further sliding operation that is carried out in the horizontal direction but the scrolling velocity is not changed in response to a further sliding operation that is carried out in the vertical direction.

[Software Implementation Example]

Control blocks of the mobile terminal 1 (particularly, the operation signal obtaining section 21, the process determining section 22, and the process executing section 23) may be realized by a logic circuit (hardware) provided in an integrated circuit (IC chip) or the like or may be realized by software as executed by a processer such as a central processing unit (CPU).

In the latter case, the mobile terminal 1 includes: a CPU that executes instructions of a program that is software realizing the foregoing functions; a read only memory (ROM) or a storage device (each referred to as “storage medium”) storing the program and various kinds of data in such a form that they are readable by a computer (or a CPU); and a random access memory (RAM) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or made available to the computer via any transmission medium (such as a communication network and a broadcast wave) which enables transmission of the program. Note that an aspect of the present invention can also be implemented by the program in the form of a computer data signal embedded in a carrier wave which is embodied by electronic transmission.

[Recap]

An information processing device (mobile terminal 1) in accordance with a first aspect of the present invention includes: a display section (display section 4) configured to display a partial region of a display object; a touch operation section (touch operation section 5) configured to accept a touch operation in which an indicator is brought into contact with or brought closer to the touch operation section; a pointer moving section (pointer moving section 232) configured to move a pointer in accordance with a moving operation which has been received by the touch operation section and in which the indicator is moved while being kept in contact with or in proximity to the touch operation section, the pointer being displayed on the display section and being for selecting a content in the display object; and a scrolling executing section (scrolling executing section 233) configured to continuously execute scrolling of the display object in a case where the pointer has reached an end of the display section by the moving operation.

According to the configuration, in a case where a user wishes to scroll the display object, the user only needs to move the pointer to an end of the display section by carrying out the moving operation. That is, in a case where the user wishes to scroll the display object, the user does not need to carry out an operation other than an operation of moving the pointer. This makes it possible to switch from moving of the pointer to scrolling of the display object by merely carrying out the moving operation. It is therefore possible to provide the user with a smooth operational feeling in a case where the user successively carries out scrolling of the display object and controlling of the pointer.

The information processing device in accordance with a second aspect of the present invention can be configured such that, in the first aspect of the present invention, in a case where the touch operation section has received, after start of scrolling of the display object, the moving operation while the indicator is kept in contact with or in proximity to the touch operation section, the scrolling executing section changes, in accordance with a direction of the moving operation, a velocity at which the display object is scrolled.

According to the configuration, the user can change the scrolling velocity by further carrying out the moving operation after start of scrolling of the display object. This makes it possible to change the scrolling velocity by merely carrying out the moving operation. It is therefore possible to provide the user with a smoother operational feeling.

The information processing device in accordance with a third aspect of the present invention can be configured such that, in the first or second aspect of the present invention, in a case where the indicator has been moved, by a further moving operation, to a position that is identified based on a position where the indicator was located when the scrolling executing section started scrolling of the display object, the scrolling executing section terminates scrolling of the display object, the further moving operation being continuous with the moving operation and carried out while the indicator is kept in contact with or in proximity to the touch operation section.

According to the configuration, it is possible to terminate scrolling of the display object by merely carrying out, after start of scrolling of the display object, a simple operation in which the indicator is moved to a position that is identified based on the position where the indicator was located when scrolling of the display object was started. Assume here that, for example, x-y plane coordinates are virtually set based on (i) an axis (i.e., x-axis) parallel to one side of the rectangle touch operation section and (ii) an axis (i.e., y-axis) perpendicular to the one side of the rectangle touch operation section, and that scrolling of the display object is continuously executed, by a moving operation carried out in a direction parallel to the x-axis (or the y-axis), in a direction identical to that of the moving operation. Under such an assumption, “the position that is identified based on the position where the indicator was located when the scrolling executing section started scrolling the display object” refers to a position whose x-coordinate (or y-coordinate) matches that of a position where the indicator was located when scrolling of the display object was started. That is, in such a case, the user carries out a moving operation so as to cause the pointer to reach an end of the display section so that the information processing device executes scrolling of the display object. Then, the user changes the position of the indicator by continuing the moving operation. After that, the user terminates scrolling of the display object by carrying out a further moving operation so as to move the indicator to a position whose x-coordinate (or y-coordinate) matches that of the position where the indicator was located on the touch operation section when the pointer reached the end of the display section.

The information processing device in accordance with a fourth aspect of the present invention can be configured to further include, in any one of the first through third aspects of the present invention, a pointer displaying section configured to cause the pointer to be displayed on the display section in a case where the touch operation has been received, the scrolling executing section terminating scrolling of the display object in a case where the indicator has been moved, by a further moving operation, to a position that is identified based on a position where the indicator was located when the pointer displaying section caused the pointer to be displayed on the display section, the further moving operation being continuous with the moving operation and carried out while the indicator is kept in contact with or in proximity to the touch operation section.

According to the configuration, it is possible to terminate scrolling of the display object by merely carrying out a simple operation in which the indicator is moved to a position that is identified based on the position where the indicator was located when the pointer was caused to be displayed. Assume here that, for example, x-y plane coordinates are virtually set based on (i) an axis (i.e., x-axis) parallel to one side of the rectangle touch operation section and (ii) an axis (i.e., y-axis) perpendicular to the one side of the rectangle touch operation section, and that scrolling of the display object is continuously executed, by a moving operation carried out in a direction parallel to the x-axis (or the y-axis), in a direction identical to that of the moving operation. Under such an assumption, “the position that is identified based on the position where the indicator was located when the pointer displaying section caused the pointer to be displayed on the display section” refers to a position whose x-coordinate (or y-coordinate) matches that of a position where the indicator was located when the pointer was caused to be displayed on the display section. That is, in such a case, the user carries out a moving operation so as to cause the pointer to reach an end of the display section so that the information processing device executes scrolling of the display object. After that, the user terminates scrolling of the display object by continuing the moving operation so as to move the pointer to a position whose x-coordinate (or y-coordinate) matches that of a position where the indicator was located when the pointer was caused to be displayed on the display section.

The information processing device in accordance with a fifth aspect of the present invention can be configured such that, in the first or second aspect of the present invention, the scrolling executing section terminates scrolling of the display object in a case where a further moving operation has been carried out in a direction opposite to that of the moving operation by which the pointer was caused to reach the end of the display section, the further moving operation being continuous with the moving operation and carried out while the indicator is kept in contact with or in proximity to the touch operation section.

According to the configuration, it is possible to terminate scrolling of the display object by merely carrying out, with the indicator, a simple moving operation in a direction opposite to that of the moving operation by which the pointer was caused to reach an end of the display section (i.e., the moving operation that was carried out to execute automatic scrolling). Since the user only needs to change the direction of the moving operation, the user can terminate scrolling of the display object without thinking about the destination of the indicator.

The information processing device in accordance with a sixth aspect of the present invention can be configured such that, in any one of the third through fifth aspects of the present invention, in a case where the touch operation section has received, after termination of scrolling of the display object, the moving operation while the indicator is kept in contact with or in proximity to the touch operation section, the pointer moving section moves the pointer in accordance with the moving operation.

According to the configuration, after termination of scrolling of the display object, the pointer displayed on the display section is moved by the moving operation that is carried out while the indicator is kept in contact with or in proximity to the touch operation section. With the configuration, after carrying out scrolling of the display object so as to cause the display section to display a desired content and then terminating scrolling of the display object, the user can move the pointer by continuing the moving operation that the user has carried out until then, and thus can cause the desired content to be selectable (e.g., cause the pointer to be located on the desired content). That is, by merely carrying out a moving operation, the user can cause the display section to display a desired content, cause the desired content to become selectable, and the like. It is therefore possible to provide the user with a smooth operational feeling.

A method of controlling an information processing device in accordance with a seventh aspect of the present invention is a method of controlling an information processing device including (i) a display section configured to display a partial region of a display object and (ii) a touch operation section configured to accept a touch operation in which an indicator is brought into contact with or brought closer to the touch operation section, the method including the steps of: moving a pointer in accordance with a moving operation which has been received by the touch operation section and in which the indicator is moved while being kept in contact with or in proximity to the touch operation section, the pointer being displayed on the display section and being for selecting a content in the display object (S7); and continuously executing scrolling of the display object in a case where the pointer has reached an end of the display section by the moving operation (S22).

According to the configuration, the method of controlling an information processing device in accordance with the seventh aspect of the present invention brings about the same effect as that brought about by the information processing device in accordance with the first aspect of the present invention.

The information processing device according to the foregoing aspects of the present invention may be realized by a computer. In this case, the present invention encompasses: a control program for the information processing device which program causes a computer to operate as each section (software element) of the information processing device so that the information processing device can be realized by the computer; and a computer-readable storage medium storing the control program therein.

An aspect of the present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: Mobile terminal (information processing device)
4: Display section
5: Touch operation section
231: Pointer displaying section
232: Pointer moving section
233: Scrolling executing section
S7: Pointer moving step
S22: Scrolling executing step

1. An information processing device, comprising:
a display section configured to display a partial region of a display object;
a touch operation section configured to accept a touch operation in which an indicator is brought into contact with or brought closer to the touch operation section;
a pointer moving section configured to move a pointer in accordance with a moving operation which has been received by the touch operation section and in which the indicator is moved while being kept in contact with or in proximity to the touch operation section, the pointer being displayed on the display section and being for selecting a content in the display object; and
a scrolling executing section configured to continuously execute scrolling of the display object in a case where the pointer has reached an end of the display section by the moving operation.

2. The information processing device as set forth in claim 1, wherein, in a case where the touch operation section has received, after start of scrolling of the display object, the moving operation while the indicator is kept in contact with or in proximity to the touch operation section, the scrolling executing section changes, in accordance with a direction of the moving operation, a velocity at which the display object is scrolled.

3. The information processing device as set forth in claim 1, wherein, in a case where the indicator has been moved, by a further moving operation, to a position that is identified based on a position where the indicator was located when the scrolling executing section started scrolling of the display object, the scrolling executing section terminates scrolling of the display object, the further moving operation being continuous with the moving operation and carried out while the indicator is kept in contact with or in proximity to the touch operation section.

4. The information processing device as set forth in claim 1, further comprising:
a pointer displaying section configured to cause the pointer to be displayed on the display section in a case where the touch operation has been received,
the scrolling executing section terminating scrolling of the display object in a case where the indicator has been moved, by a further moving operation, to a position that is identified based on a position where the indicator was located when the pointer displaying section caused the pointer to be displayed on the display section, the further moving operation being continuous with the moving operation and carried out while the indicator is kept in contact with or in proximity to the touch operation section.

5. The information processing device as set forth in claim 1, wherein the scrolling executing section terminates scrolling of the display object in a case where a further moving operation has been carried out in a direction opposite to that of the moving operation by which the pointer was caused to reach the end of the display section, the further moving operation being continuous with the moving operation and carried out while the indicator is kept in contact with or in proximity to the touch operation section.

6. The information processing device as set forth in claim 3, wherein, in a case where the touch operation section has received, after termination of scrolling of the display object, the moving operation while the indicator is kept in contact with or in proximity to the touch operation section, the pointer moving section moves the pointer in accordance with the moving operation.

7. A method of controlling an information processing device including (i) a display section configured to display a partial region of a display object and (ii) a touch operation section configured to accept a touch operation in which an indicator is brought into contact with or brought closer to the touch operation section, said method comprising the steps of:
moving a pointer in accordance with a moving operation which has been received by the touch operation section and in which the indicator is moved while being kept in contact with or in proximity to the touch operation section, the pointer being displayed on the display section and being for selecting a content in the display object; and
continuously executing scrolling of the display object in a case where the pointer has reached an end of the display section by the moving operation.

8. (canceled)
